(19) United States
(12) Patent Application Publication
(10) Pub. No.: US 2025/0371576 A1
(43) Pub. Date: Dec. 4, 2025

(54) MESSAGE NOTIFICATION MANAGEMENT IN AN ELECTRONIC DEVICE

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); HARIPRASAD SHANBHOGUE ALAMPADY, BANGALORE (IN)

(21) Appl. No.: 18/680,953

(22) Filed: May 31, 2024

(51) Int. Cl. G06Q 30/0251

(52) U.S. Cl. CPC G06Q 30/0255

(57) ABSTRACT

A computing system, a method and a computer program product for delivering advertising/promotional messages to an electronic device following a check of user satisfaction data associated with a user of the electronic device. The method includes detecting, via a processor of a computing system, at least one message for transmission to at least one electronic device. The method includes retrieving user satisfaction data corresponding to one or more users of the at least one electronic device and determining if a first user satisfaction score from the user satisfaction data of a first user is less than a first user satisfaction score threshold. In response to determining that the first user satisfaction score is less than the first user satisfaction score threshold, the method includes withholding transmission of the at least one message to a corresponding electronic device of the first user among the at least one electronic device.

### BACKGROUND

### 1. Technical Field

The present disclosure generally relates to electronic devices and in particular to managing notification messages in an electronic device.

### 2. Description of the Related Art

Electronic devices, such as mobile phones, tablets, and laptops, are widely used for video, voice, and text communication and for data transmission. Push notifications or messages offer a convenient communication medium for businesses to reach consumers with marketing content, product promotions, events and sales. An electronic device can be subscribed to specific channels hosted by a server. When new information or content becomes available on the channel, a server can automatically send a push notification or message to the subscribed electronic device. The push notification is a message that is pushed or transmitted from a server to the electronic device for surfacing via a user interface presented on the device display.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments;

FIG. 2 depicts an example computing system within which various aspects of the disclosure can be implemented, according to one or more embodiments;

FIG. 3 is a block diagram of example contents of the system memory of the example computing system of FIG. 2 configured to complete the various processes described herein, according to one or more embodiments;

FIG. 4 is an example diagram of the product/service support data of FIG. 3 illustrating one or more product/service issues associated with a product/service and/or a seller/provider of the product/service, according to one or more embodiments;

FIG. 5 is an example illustration of a display of an electronic device presenting a graphical user interface (GUI) that includes an example message or push notification that has been cleared for transmission and transmitted to the electronic device for surfacing on the device display, according to one or more embodiments;

FIG. 6 depicts a flowchart of a method by which a computing system delivers at least one message to at least one electronic device following a check of user satisfaction data associated with a user of the at least one electronic device, according to one or more embodiments; and

FIG. 7 depicts a flowchart of a method by which by which a computing system determines to implement a cooling-off period prior to delivering at least one message to at least one electronic device, according to one or more embodiments.

### DETAILED DESCRIPTION

According to one or more aspects of the disclosure, the illustrative embodiments provide a computing system, a method, and a computer program product for delivering at least one advertising/promotional message to at least one electronic device, following a check of user satisfaction data associated with a user of the electronic device. In a first embodiment, a computing system includes a communication system and a memory having stored thereon a messaging module for configuring the computing system to schedule a timing for delivery at least one message to at least one first electronic device. The computing system includes at least one processor that is communicatively coupled to the communication system and the memory. The at least one processor executes program code of the messaging module, and configures the computing system to detect at least one first message for transmission to the at least one first electronic device and to retrieve user satisfaction data corresponding to one or more users of the at least one first electronic device. The at least one processor determines if a first user satisfaction score, from the user satisfaction data of a first user, is less than a first user satisfaction score threshold. In response to determining that the first user satisfaction score is less than the first user satisfaction score threshold, the at least one processor withholds transmission of the at least one first message to a corresponding electronic device of the first user among the at least one first electronic device.

According to another embodiment, the method includes detecting, via a processor of a computing system, at least one first message for transmission to at least one first electronic device. The computing system comprising a communication system. The method includes retrieving user satisfaction data corresponding to one or more users of the at least one first electronic device and determining if a first user satisfaction score from the user satisfaction data of a first user is less than a first user satisfaction score threshold. In response to determining that the first user satisfaction score is less than the first user satisfaction score threshold, the method includes withholding transmission of the at least one first message to a corresponding electronic device of the first user among the at least one first electronic device.

According to an additional embodiment, a computer program product includes a computer readable storage device having stored thereon program code that, when executed by at least one processor of a computing system having a communication system, the program code enables the computing system to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

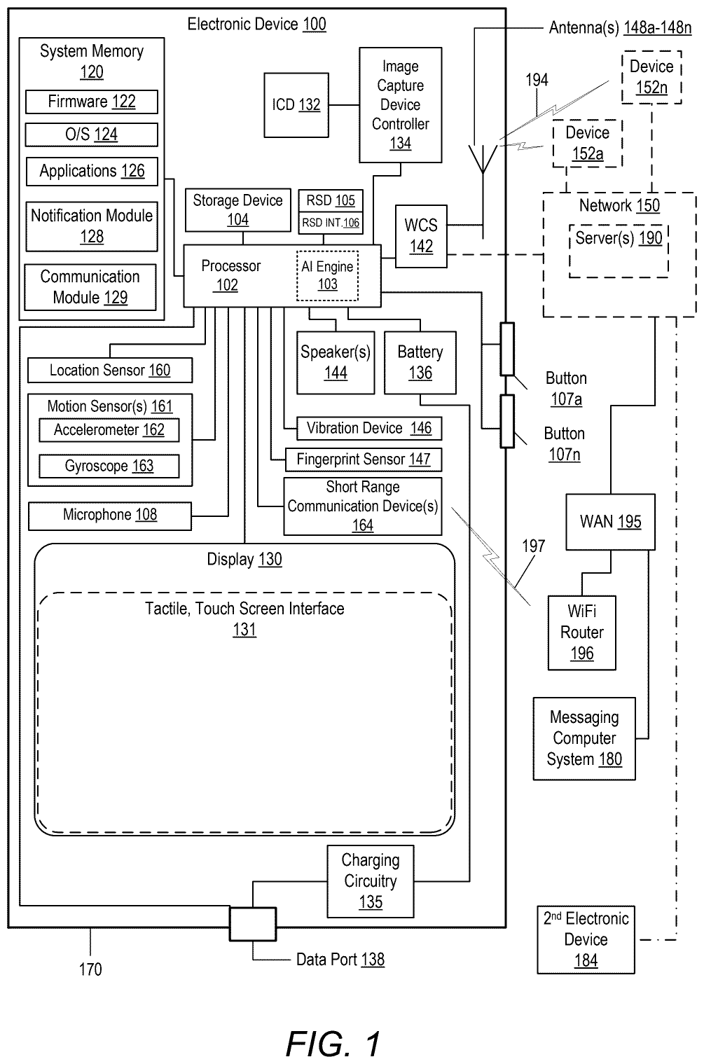

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer, and a communication device, etc. It is appreciated that electronic device 100 can be other types of devices that include the capability to transmit and receive communications. Electronic device 100 includes processor 102, which is communicatively coupled to storage device 104, system memory 120, input devices, (introduced below), output devices, such as display 130, and image capture device (ICD) controller 134. Processor 102 can include processor resources such as a primary processing unit (CPU) that support computing, classifying, processing and transmitting of data and information. Processor 102 can further include graphic processing units (GPU) and digital signal processors (DSP) that also support computing, classifying, processing and transmitting and receiving of data and information. Processor 102 can further include a hardware based artificial intelligence (AI) engine 103. Al engine 103 accelerates artificial intelligence, natural language processing (NLP), context evaluation (CE), and machine learning applications. AI engine 103 can also be implemented as a software module, in one embodiment.

System memory 120 may be a combination of volatile and non-volatile memory, such as random access memory (RAM) and read-only memory (ROM). System memory 120 can store program code and data associated with firmware 122, an operating system 124, applications 126, notification module 128, and communication module 129. Notification module 128 includes program code that is executable by processor 102, which configures electronic device 100 to receive and display messages and notifications such as push notifications. Communication module 129 includes program code that is executed by processor 102, and which configures the processor to cause electronic device 100 to communicate with other external devices and systems.

Although depicted as being separate from applications 126, notification module 128, and communication module 129 may each be implemented as an application. Processor 102 loads and executes program code stored in system memory 120, including program code associated with applications 126 and program code associated with notification module 128, and communication module 129. When processed/executed by processor 102, the program code configures the processor to cause electronic device 100 to provide the various functionality described herein.

In one or more embodiments, electronic device includes removable storage device (RSD) 105, which is inserted into an RSD interface 106 that is communicatively coupled via system interlink to processor 102. In one or more embodiments, RSD 105 is a non-transitory computer program product or computer readable storage device. In one or more embodiments, RSD 105 is a computer readable storage device encoded with program code and corresponding data, and RSD 105 can interchangeably be referred to as a non-transitory computer program product. RSD 105 may have a version of notification module 128 stored thereon, in addition to other program code. Processor 102 can access RSD 105 to provision electronic device 100 with program code that, when executed by processor 102, the program code causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device. In one or more embodiments, display 130 can be modified by operation of the processor rendering a specific sequence of coded information to present a different graphical or text window or graphical user interface within the screen of display.

Throughout the disclosure, the term image capturing device is utilized interchangeably to be synonymous with and/or refer to cameras 132. As illustrated, electronic device 100 includes camera 132 that is communicatively coupled to ICD controller 134, which is communicatively coupled to processor 102. ICD controller 134 supports the processing of signals from camera 132.

Electronic device 100 can further include charging circuitry 135, battery 136, and data port 138, for providing electrical power to the various electronic components of electronic device 100. Electronic device 100 further includes microphone 108, one or more output devices such as speaker 144, and one or more input buttons 107a-n. Input buttons 107a-n may provide controls for volume, power, and/or image capture devices 132. Microphone 108 can also be referred to as audio input device 108. Microphone 108 can be used to provide biometric data to identify or authenticate a user. Microphone 108 and input buttons 107a-n can also be referred to generally as input devices. Speaker 144 can provide an audio alert to a user of a received notification, in one embodiment.

Electronic device 100 further includes wireless communication subsystem (WCS) 142, which is coupled to antennas 148a-148n. In one or more embodiments, WCS 142 can include a communication module with one or more baseband processors or digital signal processors, one or more modems, and a radio frequency front end having one or more transmitters and one or more receivers. Wireless communication subsystem (WCS) 142 and antennas 148a-148n allow electronic device 100 to communicate wirelessly with wireless network 150 via transmissions of communication signals 194 to and from network communication devices 152a-152n, such as base stations or cellular nodes, of wireless network 150.

In one or more embodiment, wireless network 150 can include one or more servers 190 that support wireless exchange of voice, data, and video and other communication with electronic device 100 and with a second electronic device 184. Wireless network 150 further allows electronic device 100 to communicate with messaging computer system 180. Messaging computer system 180 is communicatively coupled to wireless network 150 by a wide area network (WAN) 195, such as the Internet. In an embodiment, servers 190 of wireless network 150 support wireless exchange of e-mail, text, data, push notifications and other communications between electronic device 100 and messaging computer system 180.

Second electronic device 184 is also communicatively coupled to wireless network 150. Second electronic device 184 can be similarly connected to wireless network 150, via one of network communication devices 152a-152n. In an embodiment, servers 190 of wireless network 150 support wireless exchange of voice, text, data, and video and other communication between messaging computer system 180 and second electronic device 184. While messaging computer system 180 is shown in communication with two electronic devices 100, 184, messaging computer system 180 can be in communication with more or fewer than two electronic devices.

Electronic device 100 further includes short range communication device(s) 164. Short-range communication device(s) 164 can include a low powered transceiver that can wirelessly communicate with other devices. Short-range communication device(s) 164 can include one or more of a variety of devices supporting different corresponding wireless protocols, such as a near field communication (NFC) device, a Bluetooth device, an ultra-wide band (UWB) device, and/or a wireless fidelity (Wi-Fi) device. Electronic device 100 can also connect wirelessly to wireless network 150 via communication signals 197 transmitted by short-range communication device(s) 164 to and from WiFi router 196, which is communicatively coupled to WAN 195, such as the Internet. Wireless network 150 is communicatively coupled to WAN 195.

Short-range communication device(s) 164 can wirelessly communicate with WiFi router 196 via communication signals 197. In one embodiment, electronic device 100 can receive Internet or Wi-Fi based calls via short-range communication device(s) 164. In one embodiment, electronic device 100 can communicate with WiFi router 196 wirelessly via short-range communication device(s) 164. In an embodiment, WCS 142, antennas 148a-148n and short-range communication device(s) 164 collectively provide communication interface(s) of electronic device 100.

Electronic device 100 further includes vibration device 146, fingerprint sensor 147, location sensor 160, and motion sensor(s) 161. Vibration device 146 can cause electronic device 100 to vibrate or shake when activated. Vibration device 146 can be activated to provide an alert or notification to a user of electronic device 100. According to one aspect of the disclosure, display 130, speakers 144, and vibration device 146 can generally and collectively be referred to as output devices. These output devices can be each utilized to present the different alerts to the user.

Fingerprint sensor 147 can be used to provide biometric data or images to identify or authenticate a user. Location sensor 160 can provide time data and location data about the physical location of electronic device 100. In one embodiment, location sensor 160 can be a global positioning system (GPS) device that uses data received from geospatial input received from GPS satellites.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. Electronic device 100 further includes a housing 170 that contains the components of electronic device 100.

In the description of each of the following figures, reference is also made to specific components illustrated within the preceding figure(s). Similar or same components are presented with the same leading reference number.

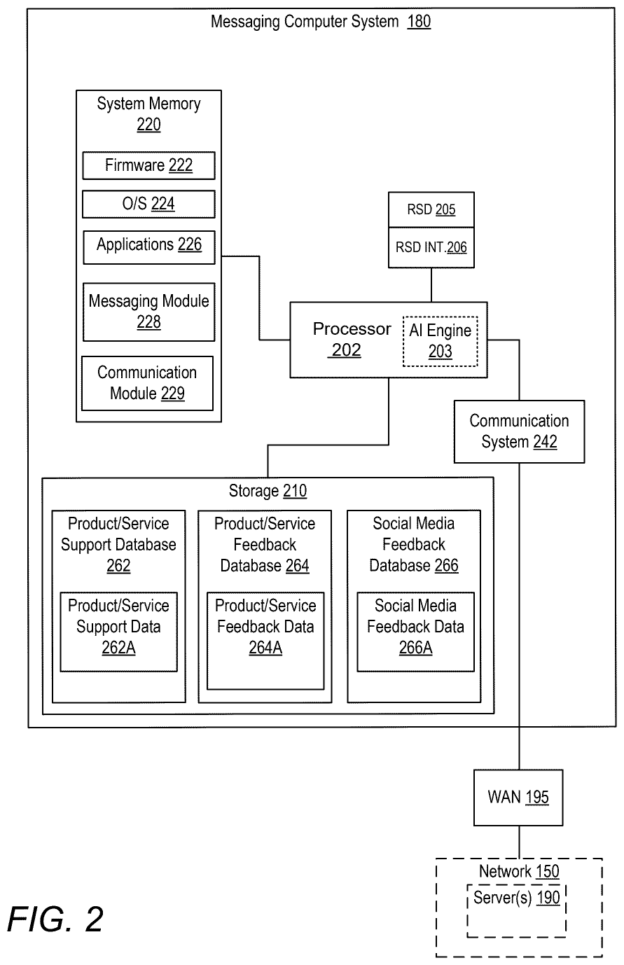

Turning to FIG. 2, messaging computer system 180 is shown in communication with wireless network 150. Messaging computer system 180 is communicatively coupled to a wide area network (WAN) 195, such as the Internet, to which server 190 of wireless network 150 is also communicatively coupled. In an embodiment, servers 190 of wireless network 150 support wireless exchange of e-mail, text, push notifications, data, and other communication between messaging computer system 180 and electronic device 100.

Messaging computer system 180 includes processor 202, which is communicatively coupled to removable storage device (RSD) 105, storage 210, system memory 220, and communication system 242. Processor 102 can include processor resources such as a primary processing unit (CPU) that support computing, classifying, processing and transmitting of data and information. Processor 102 can further include graphic processing units (GPU) and digital signal processors (DSP) that also support computing, classifying, processing and transmitting and receiving of data and information. Processor 102 can further include a hardware based artificial intelligence (AI) engine 203. AI engine 203 accelerates artificial intelligence, natural language processing (NLP), context evaluation (CE), and machine learning applications. AI engine 203 can also be implemented as a software module, in one embodiment.

In one or more embodiments, RSD 205, is inserted into an RSD interface 106 that is communicatively coupled via system interlink to processor 202. In one or more embodiments, RSD 205 is a non-transitory computer program product or computer readable storage device. In one or more embodiments, RSD 205 is a computer readable storage device encoded with program code and corresponding data, and RSD 205 can interchangeably be referred to as a non-transitory computer program product. RSD 205 may have a version of messaging module 228 stored thereon, in addition to other program code. Processor 202 can access RSD 205 to provision messaging computer system 180 with program code that, when executed by processor 202, the program code causes or configures messaging computer system 180 to provide the functionality described herein.

Messaging computer system 180 includes storage 210, such as one or more hard drives or solid state drives. Storage 210 can store product/service support database 262, product/service feedback database 264, and social media feedback database 266. Storage 210 can be or can include an external storage repository (not shown). Product/service support database 262 includes product/service support data 262A. Product/service feedback database 264 includes product/service feedback data 264A. Social media feedback database 266 includes social media feedback data 266A.

Product/service support data 262A can include reported problems or issues, support tickets, incidents and other customer issues that are associated with a product or service and/or a seller/provider of the product/service, and have been provided to messaging computer system 180. In an example embodiment, the product/service support data can be generated based on issues reported about the electronic device, and product/service feedback support data 262A can be associated with the operation of applications 126 running on electronic device 100 or can be associated with the operation of electronic device 100. In another embodiment, the product/service support data 262A can be generated based on issues reported with a product or service. Examples of products could be vehicles, appliances, clothing, and shoes. Examples of services could be insurance, health care, communication services, and entertainment services. In an additional example embodiment, product/service support data 262A can include reported problems or issues with a “service”, where the “service” can include/encapsulate both an actual service as well as the vendor/merchant/provider, such that the support data is not limited to an actual “service” such as insurance or health care, but includes the provider of that service.

In one embodiment, product/service support data 262A can be generated by an issue tracking system operating within a customer support center that resolves reported customer issues. A support ticket can include information about users (including demographic and contact information), devices, reported problems, and issue resolution status. Product/service feedback data 264A can include user comments, feedback, and other customer remarks that are associated with a product/service and/or a seller/provider of the product/service, and have been provided to messaging computer system 180. Social media feedback data 266A can include user comments, feedback and other remarks that are associated with a product/service and/or a seller/provider of the product/service. In an example embodiment, social media feedback data 266A can include information about a vendor not being customer friendly or other problems with the vendor. In one embodiment, messaging computer system 180 can screen social media posts to obtain social media feedback data 266A. Alternatively or additionally, the feedback information can be captured via another operation. In one or more embodiment, the captured data/information can be stored in a centralized social media feedback database that is accessible to the messaging computer system 180.

According to one aspect of the disclosure, messaging computer system 180 can monitor and track product/service support data 262A, product/service feedback data 264A, and social media feedback data 266A that have been received. Messaging computer system 180 can store the received product/service support data 262A, product/service feedback data 264A, and social media feedback data 266A data to databases maintained within storage 210.

System memory 220 may be a combination of volatile and non-volatile memory, such as random access memory (RAM) and read-only memory (ROM). System memory 220 can store program code and data associated with firmware 222, an operating system 224, applications 226, messaging module 228, and communication module 229. Messaging module 228 includes program code that is executable by processor 202 to configure messaging computer system 180 to manage and deliver messages to one or more electronic devices. Communication module 229 includes program code that is executed by processor 202 to enable messaging computer system 180 to communicate with other external devices and systems.

Processor 202 loads and executes program code stored in system memory 220, including program code associated with applications 226 and program code associated with messaging module 228, and communication module 229. When processed/executed by processor 202, the program code causes or configures messaging computer system 180 to provide the various functionality described herein.

Communication system 242 allows messaging computer system 180 to communicate with WAN 195 and network 150. In one embodiment, communication system 242 can include one or more network interface controllers and other components.

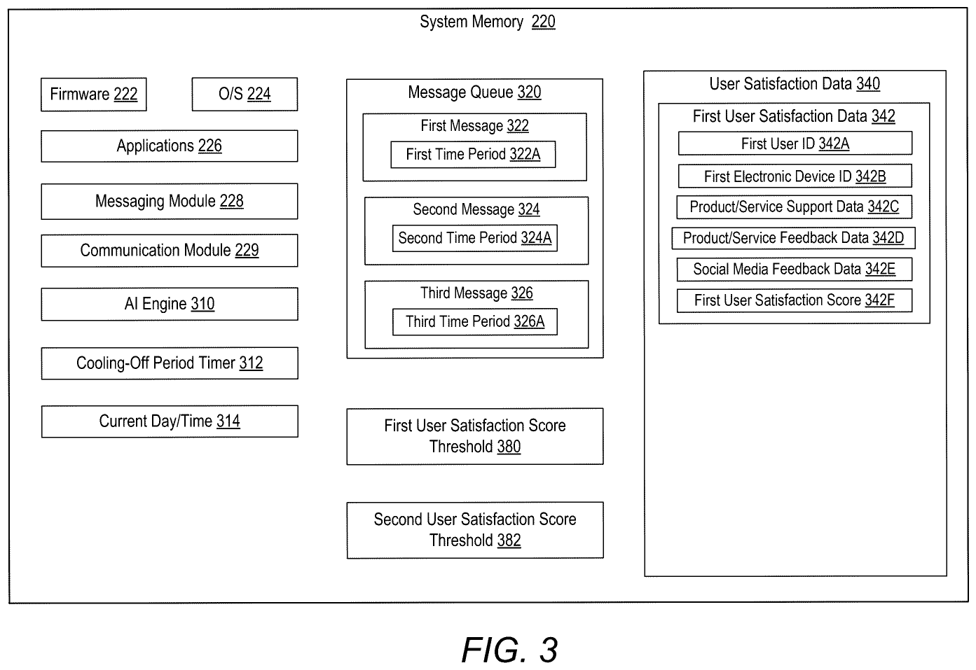

Referring to FIG. 3, there is shown one embodiment of example contents of system memory 220 of messaging computer system 180 configured to complete the various processes described herein. System memory 220 includes data, software, and/or firmware modules, including firmware 222, an operating system (O/S) 224, applications 226, messaging module 228, and communication module 229.

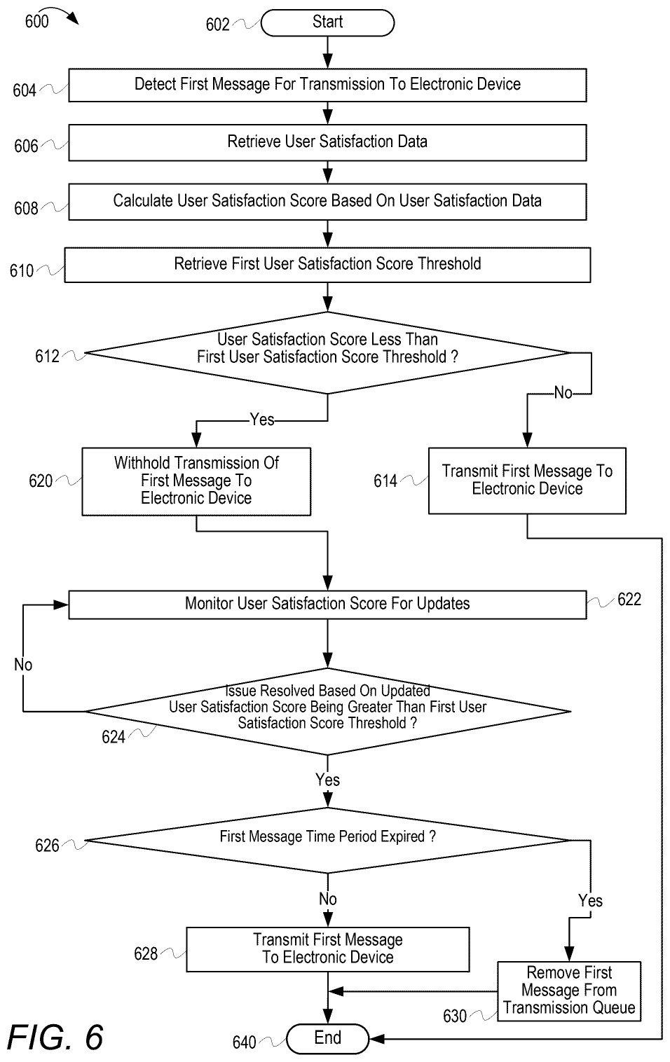

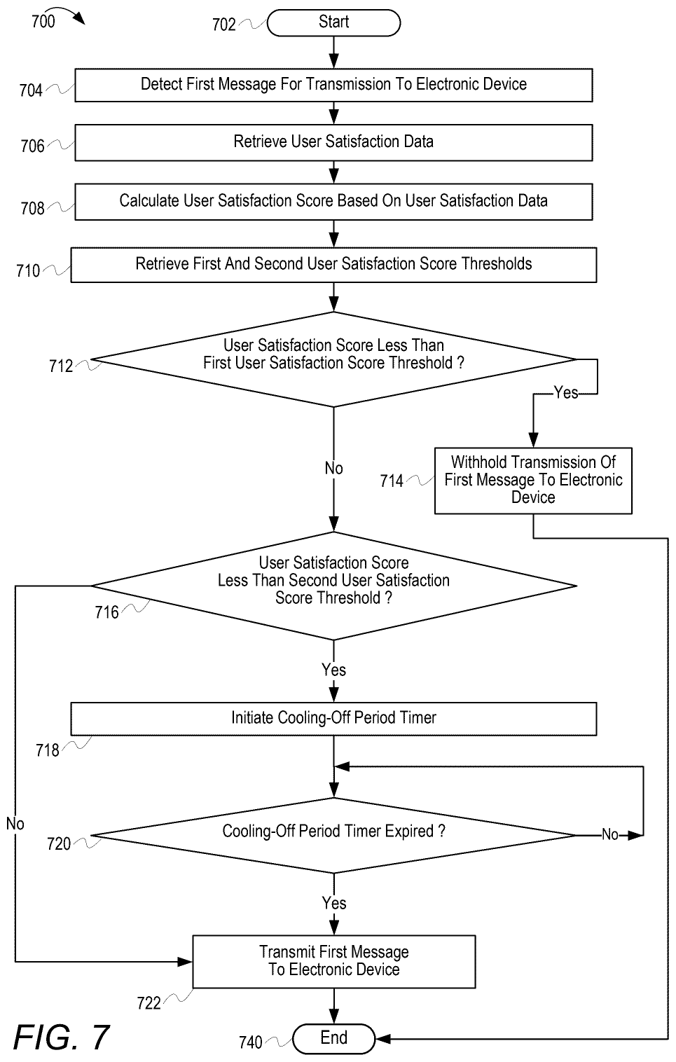

Messaging module 228 includes program code that is executed by processor 102 to configure electronic device 100 to perform the various features of the present disclosure. In one or more embodiments, messaging module 228 configures messaging computer system 180 to determine whether to deliver advertisement/promotional messages to at least one electronic device and/or a time for delivering the advertisement/promotional messages based, in part, on an analysis of a user's current level of satisfaction or dissatisfaction with the supplier and/or the product/service being advertised/promoted. In one or more embodiments, execution of messaging module 228 by processor 202 configures messaging computer system 180 to perform the processes presented in the flowcharts of FIGS. 6 and 7, as will be described below. Communication module 229 configures messaging computer system 180 to communicate and exchange data with other devices via WAN 195 and wireless network 150.

System memory 220 includes artificial intelligence (AI) engine 310, cooling-off period timer 312 and current day/time 314. AI engine 310 can accelerate artificial intelligence, natural language processing (NLP), context evaluation (CE), and machine learning applications. Cooling-off period timer 312 can track a preset amount of time or time period before new messaging advertising/promotion of a particular service/product/vendor is provided or transmitted to electronic device 100. Cooling-off period timer 312 allows a period of time to expire before a user with some level of dissatisfaction about the content or originator of the message is sent the message. Current day/time 314 includes the current day/month/year and the current time of the day.

System memory 220 includes message queue 320. Message queue 320 is a list of messages that are waiting to be transmitted to one or more electronic devices. In one embodiment, messages contained in message queue 320 can be push notifications that are transmitted by messaging computer system 180 to one or more electronic devices. In an embodiment, messages contained in message queue 320 are associated with communications from a customer relationship management (CRM) system that a business or other organization uses to interact with customers.

Message queue 320 includes first message 322, second message 324 and third message 326. First message 322 includes a first time period 322A. First time period 322A is a period of time during which the first message is to be transmitted. After the first time period 322A has expired, the first message 322 is no longer to be transmitted. Similarly, second message 324 includes a second time period 324A and third message 326 includes a third time period 326A. Each message can be sent to multiple different user devices at any time during its respective valid time period. For example, the first message 322 can be broadcast to a first set of user devices as a batch message transmission for immediate notification of corresponding users. Transmission of the first message 322 to one or more particular user device(s) may however be withheld completely or delayed by a cooling off period (within the available first time period) because of (i) a pending unresolved issue raised by the user(s) of the one or more particular user device(s) or (ii) a negative posting by the user about the product/service/supplier presented by the message, etc. or (iii) negative social media postings about the product/service/supplier presented by the message.

System memory 220 includes user satisfaction data 340. User satisfaction data 340 includes first user satisfaction data 342 First user satisfaction data 342 is associated with a first user of a corresponding first electronic device

First user satisfaction data 342 includes a first user identifier (ID) 342A, a first electronic device ID 342B (e.g., a phone number) associated with the first user, product/service support data 342C associated with the first user, product/service feedback data 342D associated with the product/service or vendor/supplier/merchant, social media feedback data 342E from the user associated with product/service or vendor/supplier/merchant, and first user satisfaction score 342F. Product/service support data 342C, product/service feedback data 342D and social media feedback data 342E are retrieved from databases of storage 210 and stored to system memory 120.

The first user satisfaction score 342F is calculated based on the product/service support data 342C, product/service feedback data 342D, and social media feedback data 342E. As an example, a score range of 1 to 10 can be provided, where a 1 indicates a low user satisfaction score and a 10 indicates a high user satisfaction score. In one embodiment, a certain level of the first user satisfaction score (e.g., below 5 on a 10 point scale, with 10 being the highest level of satisfaction) is indicative of an ongoing negative experience and is an absolute blocker for the transmission of messages (i.e., no advertising messages are transmitted to the user device from that provider/supplier). An absolute blocker issue is a customer/user issue that has an associated high level of customer/user dissatisfaction that is severe enough to withhold the transmission of messages. In another embodiment, where there is no blocker issue based on a certain level of the first user satisfaction score (e.g., between 5 and 7 on a 10 point scale, with 10 being the highest level of satisfaction) can be classified as general negative feedback that triggers a cooling-off period before the transmission and surfacing of new promotional messages/notifications.

Continuing with this example, messages about the product/service or vendor/supplier/merchant are transmitted to the user device only when the user's corresponding satisfaction score is a 7 or above. Additionally, with this example, delayed transmission based on a cooling off period can be triggered when the first user has provided a corresponding low satisfaction score of 6 or below for less than a week, where the issue was subsequently resolved to allow the score to be increased above a 7. Finally, with this example, no transmission of the message (i.e., an absolute blocker issue) is made to the user device if the satisfaction score is a 5 or below.

According to one aspect of the disclosure, to determine the first user satisfaction score 342F, messaging computing system 180 (i) retrieves, from product/service support database 262, any product/service support data 262A associated with the at least one first electronic device (e.g., electronic device 100), (ii) retrieves, from product/service feedback database 264, any product/service feedback data 264A associated with the at least one first electronic device and (iii) retrieves, from social media feedback database 266, any social media feedback data 266A associated with the at least one first electronic device. Messaging computing system 180 calculates the first user satisfaction score 342F based on the retrieved ones of the product/service support data 262A, the product/service feedback data 264A, and the social media feedback data 266A. If there is not data corresponding to the product/service or supplier/vendor/merchant that is the subject or originator of the advertisement/promotional message, no user satisfaction score is calculated and a default setting is provided for the first user to automatically be included in the initial broadcast of the message.

In an alternate embodiment, the user satisfaction score 342F can be determined by the number of complaints raised by the user directed at the particular product/service, etc. where the score is decreased for every negative report or posting made by the user. In another embodiment, rather than track a user satisfaction score, the messaging computing system 180 can be configured to track a level of user dissatisfaction and utilize the level of dissatisfaction to determine whether or not to present the message. In the example scenario, a zero can indicate that the user is not dissatisfied and a default value of 0 can be assumed for every user unless or until that user has an issue to be resolved or posts a negative or neutral (i.e., not positive) feedback or rating to a product/service review or on social media.

In one embodiment, each of product/service support data 342C, product/service feedback data 342D and social media feedback data 342E can be assigned a numerical rating that corresponds to a user's level of satisfaction. In an example embodiment, each of product/service support data 342C, product/service feedback data 342D and social media feedback data 342E can be assigned a numerical value from 1 to 10, with 1 being dissatisfied and 10 being satisfied. In one embodiment, the values of the product/service support data 342C, product/service feedback data 342D and social media feedback data 342E can be averaged to calculate the first user satisfaction score 342F. In another embodiment, the values of the product/service support data 342C may be weighted higher than the other values in calculating the first user satisfaction score 342F.

System memory 220 includes first user satisfaction score threshold 380 and second user satisfaction score threshold 382. First user satisfaction score threshold 380 is a pre-determined minimum value of the user satisfaction score that indicates that the user is not satisfied with their experience with a product or service or supplier/vendor/merchant/manufacturer. A first user satisfaction score below the first user satisfaction score threshold 380 can indicate a negative user experience. In one example embodiment, the first user satisfaction score threshold 380 can be assigned a value of “4”. A user satisfaction score less than or below “4” can indicate a negative user experience. Second user satisfaction score threshold 382 is a pre-determined value of the user satisfaction score that indicates that the user has a moderate user experience and that some concerns or issues are not fully resolved with a product or service. In one example embodiment, the second user satisfaction score threshold 382 can be assigned a value of “7”. A user satisfaction score greater than “4” and less than “7” can indicate a moderate user experience that triggers a cooling-off waiting period before new messaging is transmitted to the user.

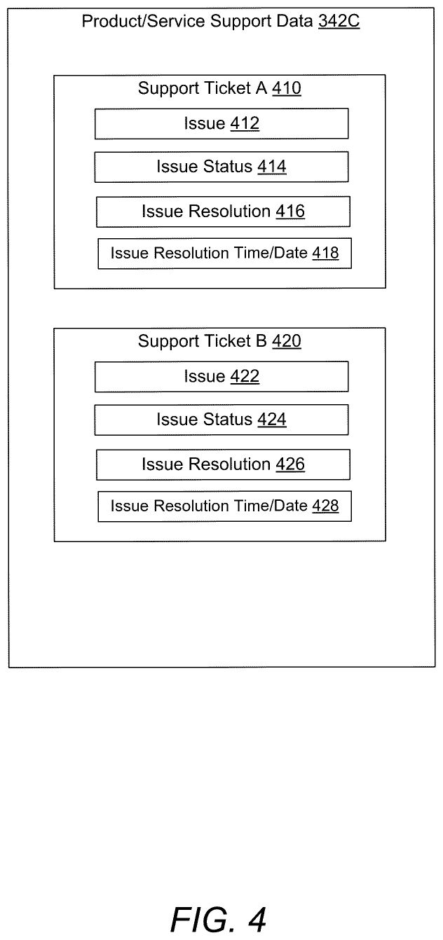

With reference to FIG. 4, additional details of the contents of product/service support data 342C of FIG. 3 are shown. Product/service support data 342C includes support ticket A 410 and support ticket B 420. Support ticket A 410 and support ticket B 420 can be generated in response to a customer problem, incident, and/or other customer issues that are associated with at least one aspect of a product or service or supplier/vendor/merchant/manufacturer and have been provided to messaging computer system 180. In the example of the issue being related to the first electronic device, support ticket A 410 and support ticket B 420 can be associated with an aspect of the operation of electronic device 100.

Support ticket A 410 includes issue 412, issue status 414, issue resolution 416 and issue resolution time/date 418. Similarly, Support ticket B 420 includes issue 422, issue status 424, issue resolution 426 and issue resolution time/date 428. Issue 412 is a detailed description of the problem or issue that a user is having. In one example embodiment, issue 412 may be that an electronic device is not charging to full battery capacity. In another example embodiment, issue 412 may be that an application is not operating on electronic device. Issue status 414 is the current status of the issue (e.g., resolved or unresolved). Issue resolution 416 is how the issue was resolved, and issue resolution time/date 418 is the date and time that the issue was resolved. In one embodiment, issue resolution time/date 418 can also indicate the length of time it took for the issue to be resolved once the issue was first reported.

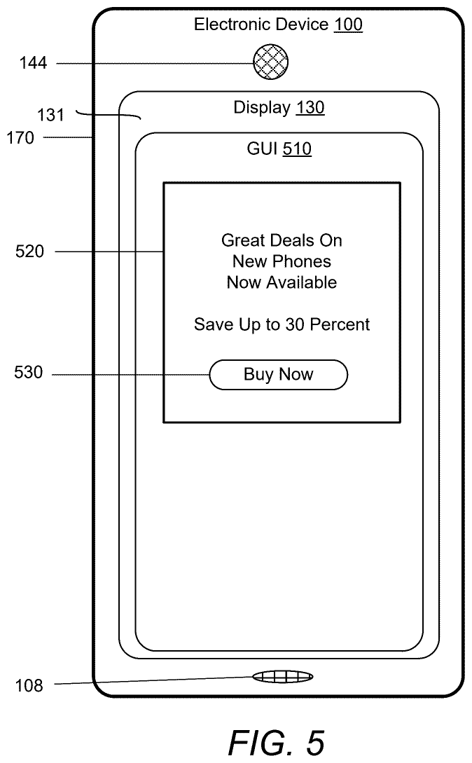

With reference to FIG. 5, electronic device 100 is shown with an example message notification graphical user interface (GUI) 510 presented on display 130. Electronic device 100 can surface received messages (e.g., push notifications) on display 130. Message notification GUI 510 is surfaced on display 130 after electronic device 100 has received a message (e.g., first message 322) from messaging computer system 180 for presenting on electronic device 100. Message notification GUI 510 includes a message 520 such as a notification that a product is now available or is on sale. Message notification GUI 510 further includes selectable buy now option 530. When selected, buy now option 530 enables electronic device 100 to communicate with an online shopping interface (i.e., a shopping website) where a user can add the corresponding item(s) to an online shopping cart and purchase the item(s).

According to one aspect of the disclosure, messaging computing system 180 can detect at least one first message 322 for transmission to an electronic device 100 and retrieve user satisfaction data 340 corresponding to one or more users of electronic device 100. Messaging computing system 180 can determine if a first user satisfaction score 342F, from the user satisfaction data 340 of a first user, is less than a first user satisfaction score threshold 380. In response to determining that the first user satisfaction score 342F is less than the first user satisfaction score threshold 380, messaging computing system 180 withholds transmission of the at least one first message 322 to electronic device 100 of the first user.

According to another aspect of the disclosure, messaging computing system 180 can delay transmission of the first message 322 and periodically check an issue tracking source/database to identify if a first issue 412 associated with the first user satisfaction score 342F has been resolved. In response to identifying that the first issue 412 associated with the first user satisfaction score 342F has been resolved and that the first message 322 is waiting for transmission (and is still within an established transmission window), messaging computing system 180 transmits the first message 322 to at least one electronic device 100.

According to an additional aspect of the disclosure, to identify whether the first issue 412 has been resolved, messaging computing system 180 monitors the first user satisfaction score 342F for updates to the first user satisfaction score and determines if an updated first user satisfaction score is more than the first user satisfaction score threshold 380. In another embodiment, messaging computing system 180 can monitor responses from the first user about the status of the first issue 412, and messaging computing system 180 identifies the status as resolved based on the responses from the first user to a query about the issue or an updated issue status posted within the issue tracking database. In response to determining that the updated first user satisfaction score is more than the first user satisfaction score threshold 380 or otherwise determining that the issue status is resolved, messaging computing system 180 determines if the at least one first message 322 is waiting for transmission to electronic device 100. In response to determining that the at least one first message 322 is waiting for transmission to electronic device 100, messaging computing system 180 transmits the at least one first message 322 to electronic device 100.

According to yet another aspect of the disclosure, in response to determining that the updated first user satisfaction score is not more than the first user satisfaction score threshold 380, messaging computing system 180 continues to withhold transmission of the at least one first message 322 to electronic device 100.

According to one more aspect of the disclosure, in response to determining that a first time period 322A for transmitting the at least one first message 322 to electronic device 100 has expired, messaging computing system 180 removes the at least one first message 322 from a message transmission queue 320. Accordingly, the particular message is never transmitted to the user device when there is an unresolved issue or while the user's satisfaction score is below the established threshold level for transmitting the message.

According to still another aspect of the disclosure, messaging computing system 180 can determine if the first user satisfaction score 342F indicates that the first user of electronic device 100 is not fully satisfied because of a prior first issue that has recently been resolved. In response to determining that the first user satisfaction score 342F indicates that the first user of electronic device 100 is not fully satisfied because of a prior first issue (e.g., issue 412) that has recently been resolved, messaging computing system 180 initiates a cooling-off period timer 312 with a preset amount of time before new messaging is provided to electronic device 100 of the corresponding first user. Messaging computing system 180 monitors for expiration of the cooling-off period timer 312. In response to expiration of the cooling-off period timer 312, messaging computing system 180 transmits the at least one first message 322 to electronic device 100 of the corresponding first user.

FIG. 6 depicts method 600 by which messaging computing system 180 delivers at least one message to at least one electronic device following a check of user satisfaction data associated with a user of the at least one electronic device. FIG. 7 depicts method 700 by which messaging computing system 180 delivers at least one message to at least one electronic device following a cooling-off period.

The description of methods 600 and 700 will be described with reference to the devices and components thereof and examples of FIGS. 1-5. The operations depicted in FIGS. 6 and 7 can be performed by messaging computing system 180 or any suitable computing system that includes the one or more functional components of messaging computing system 180 that provide/enable the described features. One or more of the processes of the methods described in FIGS. 6 and 7 may be performed by processor 202 executing program code associated with messaging module 228 and configuring the messaging computing system to perform the various processes.

With specific reference to FIG. 6 method 600 begins at the start block 602. At block 604, method 600 includes detecting a first message (e.g., first message 322) for transmission to at least one electronic device 100. Method 600 includes retrieving user satisfaction data 340 corresponding to one or more users of electronic device 100 (block 606). Method 600 includes calculating the first user satisfaction score 342F based on the retrieved user satisfaction data 340 (i.e., one or more of product/service support data 342C, product/service feedback data 342D, and social media feedback data 342E) (block 608). Method 600 includes retrieving the first user satisfaction score threshold 380 (block 610).

At decision block 612, method 600 includes determining, if the first user satisfaction score 342F associated with a first user, is less than a first user satisfaction score threshold 380. In response to determining that the first user satisfaction score 342F is not less than the first user satisfaction score threshold 380, method 600 includes transmitting the at least one first message 322 to electronic device 100 of the first user (block 614) to trigger surfacing of the notification on the display of the electronic device 100. Method 600 ends at end block 640.

In response to determining that the first user satisfaction score 342F is less than the first user satisfaction score threshold 380, method 600 includes withholding transmission of the at least one first message 322 to electronic device 100 of the first user (block 620). Method 600 includes monitoring the first user satisfaction score 342F for updates to the first user satisfaction score (block 622).

At decision block 624, method 600 includes determining, if a first issue 412 associated with the first user satisfaction score 342F has been resolved based on an updated first user satisfaction score 342F associated with a first user being greater or more than the first user satisfaction score threshold 380. In response to determining that the first issue 412 associated with the first user satisfaction score 342F has not been resolved (e.g., based on the updated first user satisfaction score 342F not being greater than the first user satisfaction score threshold 380), method 600 continues to monitor the first user satisfaction score 342F for updates to the first user satisfaction score (block 622) until expiration of a message transmission timer that establishes a time during which the message is to be transmitted.

In response to determining that the first issue 412 associated with the first user satisfaction score 342F has been resolved (e.g., based on the updated first user satisfaction score 342F being greater than the first user satisfaction score threshold 380), method 600 includes determining if the first message is waiting for transmission (e.g., by determining if the first time period 322A for transmitting the first message 322 has expired) (decision block 626). In response to determining that the first time period 322A for transmitting the first message 322 has expired, method 600 includes removing the first message 322 from the message queue 320 (block 630). In response to determining that the first time period 322A for transmitting the first message 322 has not expired, method 600 includes transmitting the at least one first message 322 to electronic device 100 of the first user (block 628). Method 600 ends at end block 640.

With reference to FIG. 7, method 700 begins at the start block 702. At block 704, method 700 includes detecting a first message (e.g., first message 322) for transmission to at least one electronic device 100. Method 700 includes retrieving user satisfaction data 340 corresponding to one or more users of electronic device 100 (block 706). Method 700 includes calculating the first user satisfaction score 342F based on the retrieved user satisfaction data 340 (i.e., ones of the product/service support data 342C, the product/service feedback data 342D, and the social media feedback data 342E) (block 708). Method 700 includes retrieving the first user satisfaction score threshold 380 and the second user satisfaction score threshold 382 (block 710).

At decision block 712, method 700 includes determining, if the first user satisfaction score 342F associated with a first user, is less than a first user satisfaction score threshold 380. In response to determining that the first user satisfaction score 342F is less than the first user satisfaction score threshold 380, method 700 includes withholding transmission of the at least one first message 322 to electronic device 100 of the first user (block 714). Method 700 ends at end block 740.

In response to determining that the first user satisfaction score 342F is not less than the first user satisfaction score threshold 380, method 700 includes determining if the first user satisfaction score 342F is less than the second user satisfaction score threshold 382 (decision block 716). In response to determining that the first user satisfaction score 342F is not less than the second user satisfaction score threshold 382, method 700 includes transmitting the at least one first message 322 to electronic device 100 of the first user (block 722). Method 700 ends at end block 740. In response to determining that the first user satisfaction score 342F is less than the second user satisfaction score threshold 382, method 700 includes initiating cooling-off period timer 312 (block 718).

The first user satisfaction score being between the first and second user satisfaction score thresholds 380, 382 can indicate that a user of electronic device 100 is not fully satisfied because of a prior first issue (i.e., issue 412) that has recently been resolved. Cooling-off period timer 312 enables a preset amount of time to lapse before new messaging is provided to electronic device 100 of the corresponding user who may not be fully satisfied because of the prior first issue that has recently been resolved.

At decision block 720, method 700 includes determining if the cooling-off period timer 312 has expired. In response to determining that the cooling-off period timer 312 has not expired, method 700 continues to wait and periodically checks to determine if the cooling-off period timer 312 has expired. In response to determining that the cooling-off period timer 312 has expired, method 700 includes transmitting the at least one first message 322 to electronic device 100 of the first user (block 722) to trigger the electronic device to surface a GUI (e.g., GUI 510) presenting the message on the device display. Method 700 ends at end block 740.

In the above-described methods of FIGS. 6 and 7, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

1. A computing system comprising:
a communication system;
a memory having stored thereon a messaging module for delivering at least one message to at least one first electronic device; and
at least one processor communicatively coupled to the communication system and the memory, the at least one processor executing program code of the messaging module, the at least one processor configures the computing system to:
detect at least one first message for transmission via a network to the at least one first electronic device;
retrieve user satisfaction data corresponding to one or more users of the at least one first electronic device;
determine if a first user satisfaction score from the user satisfaction data of a first user is less than a first user satisfaction score threshold;
in response to determining that the first user satisfaction score is less than the first user satisfaction score threshold, withhold transmission of the at least one first message to a corresponding electronic device of the first user among the at least one first electronic device; and
in response to determining that the first user satisfaction score is not less than the first user satisfaction score threshold, transmits, via the communication system and the network, the at least one first message to the at least one first electronic device.

2.

[symbol]

3. The computing system of claim 1, wherein the user satisfaction data associated with the at least one first electronic device comprises at least one of product/service support data, product/service feedback data, and social media data associated with a user satisfaction with a product or service or one or more of a supplier, vendor, merchant, or manufacturer.

4. The computing system of claim 1, wherein the at least one processor:
identifies if a first issue associated with the first user satisfaction score has been resolved; and
in response to identifying that the first issue associated with the first user satisfaction score has been resolved and that the at least one first message is waiting for transmission, transmits the at least one first message to the at least one first electronic device.

5. The computing system of claim 4, wherein:
to identify whether the first issue has been resolved, the at least one processor:
monitors the first user satisfaction score for updates to the first user satisfaction score; and
determines if an updated first user satisfaction score is more than the first user satisfaction score threshold; and
the at least one processor:
in response to determining that the updated first user satisfaction score is more than the first user satisfaction score threshold, determines if the at least one first message is waiting for transmission to the at least one first electronic device; and
in response to determining that the at least one first message is waiting for transmission to the at least one first electronic device, transmits the at least one first message to the at least one first electronic device.

6. The computing system of claim 5, wherein the at least one processor:
in response to determining that the updated first user satisfaction score is not more than the first user satisfaction score threshold, continues to withhold transmission of the at least one first message to the at least one first electronic device.

7. The computing system of claim 5, wherein the at least one processor:
in response to determining that a first time period for transmitting the at least one first message to the at least one first electronic device has expired, removes the at least one first message from a message transmission queue.

8. The computing system of claim 1, wherein, to determine the first user satisfaction score, the at least one processor completes at least one of:
retrieves, from a product/service support database, any product/service support data associated with the at least one first electronic device;
retrieves, from a product/service feedback database, any product/service feedback data associated with the at least one first electronic device; and
retrieves, from a social media feedback database, any social media feedback data associated with the at least one first electronic device; and
calculates the first user satisfaction score based on retrieved ones of the product/service support data, the product/service feedback data, and the social media feedback data.

9. The computing system of claim 1, wherein the at least one processor:
determines if the first user satisfaction score indicates that the first user of the at least one first electronic device is not fully satisfied because of a prior first issue that has recently been resolved;
in response to determining that the first user satisfaction score indicates that the first user of the at least one first electronic device is not fully satisfied because of a prior first issue that has recently been resolved, initiates a timer with a preset amount of time before new messaging is provided to the at least one first electronic device of the corresponding first user;
monitors for expiration of the timer; and
in response to expiration of the timer, transmits the at least one first message to the at least one first electronic device of the corresponding first user.

10. A method comprising:
detecting, via a processor of a computing system, at least one first message for transmission, via a network, to at least one first electronic device, the computing system comprising a communication system;
retrieving user satisfaction data corresponding to one or more users of the at least one first electronic device;
determining if a first user satisfaction score from the user satisfaction data of a first user is less than a first user satisfaction score threshold;
in response to determining that the first user satisfaction score is less than the first user satisfaction score threshold, withholding transmission of the at least one first message to a corresponding electronic device of the first user among the at least one first electronic device; and
in response to determining that the first user satisfaction score is not less than the first user satisfaction score threshold, transmitting, via the communication system and the network, the at least one first message to the at least one first electronic device.

11. (canceled)

12. The method of claim 10, wherein the user satisfaction data associated with the at least one first electronic device comprises at least one of product/service support data, product/service feedback data, and social media data associated with a user satisfaction with a product or service or one or more of a supplier, vendor, merchant, or manufacturer.

13. The method of claim 10, further comprising:
identifying if a first issue associated with the first user satisfaction score has been resolved; and
in response to identifying that the first issue associated with the first user satisfaction score has been resolved and that the at least one first message is waiting for transmission, transmitting the at least one first message to the at least one first electronic device.

14. The method of claim 13, wherein identifying whether the first issue has been resolved, the method further comprises:
monitoring the first user satisfaction score for updates to the first user satisfaction score;
determining if an updated first user satisfaction score is more than the first user satisfaction score threshold;
in response to determining that the updated first user satisfaction score is more than the first user satisfaction score threshold, determining if the at least one first message is waiting for transmission to the at least one first electronic device; and
in response to determining that the at least one first message is waiting for transmission to the at least one first electronic device, transmitting the at least one first message to the at least one first electronic device.

15. The method of claim 14, further comprising:
in response to determining that the updated first user satisfaction score is not more than the first user satisfaction score threshold, continue withholding transmission of the at least one first message to the at least one first electronic device.

16. The method of claim 14, further comprising:
in response to determining that a first time period for transmitting the at least one first message to the at least one first electronic device has expired, removes the at least one first message from a message transmission queue.

17. The method of claim 10, wherein to determine the first user satisfaction score, the method further comprises:
retrieving from a product/service support database, any product/service support data associated with the first electronic device;
retrieving from an product/service feedback database, any product/service feedback data associated with the first electronic device;
retrieving from a social media database, any social media feedback data associated with the first electronic device; and
calculating the first user satisfaction score based on retrieved ones of the product/service support data, the product/service feedback data, and the social media feedback data.

18. The method of claim 10, further comprising:
determining if the first user satisfaction score indicates that the first user of the at least one first electronic device is not fully satisfied because of a prior first issue that has recently been resolved;
in response to determining that the first user satisfaction score indicates that the first user of the at least one first electronic device is not fully satisfied because of a prior first issue that has recently been resolved, initiating a timer with a preset amount of time before new messaging is provided to the at least one electronic device of the corresponding first user;
monitors for expiration of the timer; and
in response to expiration of the timer, transmitting the at least one first message to the at least one first electronic device of the corresponding first user.

19. A computer program product comprising:
a non-transitory computer readable storage device having stored thereon program code which, when executed by at least one processor of a computing system having a communication system configures the computing system to complete the functionality of:
detecting at least one first message for transmission, via a network, to at least one first electronic device;
retrieving user satisfaction data corresponding to one or more users of the at least one first electronic device;
determining if a first user satisfaction score from the user satisfaction data of a first user is less than a first user satisfaction score threshold;
in response to determining that the first user satisfaction score is less than the first user satisfaction score threshold, withholding transmission of the at least one first message to a corresponding electronic device of the first user among the at least one first electronic device; and
in response to determining that the first user satisfaction score is not less than the first user satisfaction score threshold, transmitting, via the communication system and the network, the at least one first message to the at least one first electronic device.

20. (canceled)

21. The computer program product of claim 19, wherein the program code comprises code that configures the processor to cause the computing system to complete the functionality of:
identifying if a first issue associated with the first user satisfaction score has been resolved; and
in response to identifying that the first issue associated with the first user satisfaction score has been resolved and that the at least one first message is waiting for transmission, transmitting the at least one first message to the at least one first electronic device.

22. The computer program product of claim 21, wherein the program code for identifying whether the first issue has been resolved, comprises code that configures the processor to cause the computing system to complete the functionality of:
monitoring the first user satisfaction score for updates to the first user satisfaction score; determining if an updated first user satisfaction score is more than the first user satisfaction score threshold;
in response to determining that the updated first user satisfaction score is more than the first user satisfaction score threshold, determining if the at least one first message is waiting for transmission to the at least one first electronic device; and
in response to determining that the at least one first message is waiting for transmission to the at least one first electronic device, transmitting the at least one first message to the at least one first electronic device.

23. The computer program product of claim 19, wherein the program code further comprises code that configures the processor to cause the computing system to complete the functionality of:
determining if the first user satisfaction score indicates that the first user of the at least one first electronic device is not fully satisfied because of a prior first issue that has recently been resolved;
in response to determining that the first user satisfaction score indicates that the first user of the at least one first electronic device is not fully satisfied because of a prior first issue that has recently been resolved, initiating a timer with a preset amount of time before new messaging is provided to the at least one electronic device of the corresponding first user;
monitors for expiration of the timer; and
in response to expiration of the timer, transmitting the at least one first message to the at least one first electronic device of the corresponding first user.
